(19) United States
(12) Patent Application Publication
(10) Pub. No.: US 2009/0319377 A1
(43) Pub. Date: Dec. 24, 2009

(54) BUSINESS METHOD FOR SELF PROMOTION AND MARKETING

(75) Inventors: Marina GAZETOVA, Visaginas (LT); Liudmila Gazetova, Visaginas (LT); Rafael Gazetov, Visaginas (LT)

Correspondence Address: YOUNG & THOMPSON, 209 Madison Street, Suite 500, Alexandria, VA, 22314, US

(73) Assignee: UAB "IEEC", Vilnius (LT)

(21) Appl. No.: 12/120,249

(22) Filed: May 14, 2008

(51) Int. Cl. G06Q 30/00

(52) U.S. Cl. 705/14.73; 705/1

(57) ABSTRACT

A business method for self promotion and marketing is performed through mass influence on users by means of tangible or intangible unsolicited information services or other unsolicited person's or legal entity's attributes of personal, pseudo-personal or impersonal character or by means of their mass distribution among users through the use of visual, sound, communicational, tele-communicational and others ways of distribution from hidden or real addresses and under real or false names of senders, using radio, television, telephone, mail, signs, posters, monitors, the Internet, and other tangible or intangible unsolicited information services or other unsolicited person's or legal entity's attributes, that cause increase of mail, telephone, e-mail and other traffic and result in increase of demand for products and services, which encourages users to buy these products and services or other person's or legal entity's attributes.

### FIELD OF THE INVENTION

The present invention relates to Internet based technologies, and it's purpose is to protect users from mass influence on them by unsolicited advertisement as well as from receiving unsolicited information services or other unsolicited person's or legal entity's attributes. Self promotion and marketing (spam) industry is a serious problem for people in many countries, and it is distributed primarily through tele-communicational networks which combine owners of information networks and technologies with work distribution and technological chain of all participants. The main characteristics of spam are mass distribution, non-coordination with receivers and anonymity of senders. Spam has advertising or other commercial character, and practically in all cases it has illegal tint, though no national laws are broken; and it makes struggle against spam to be very difficult on a legal level.

The present invention is a global and effective way of organizing a civilized spam market, as far as spam is acknowledged to be a real global threat to the Internet, and legal protection of users from spam can be effective only if it becomes international, however, the process of passing a universal anti-spam law in all countries of the world community is a long and complicated one.

The present invention is an important legal part of complex global attitude to solving the problem of spam, which is being struggled against on legal, technological, and social levels; it will provide effective means against spam distribution with minimization of its volumes; and it is an important element of supporting favorable conditions for use of the global network Internet and ensuring preservation of its entirety.

The present invention allows to put spam business into a civilized channel and to cover the whole legal field of the Internet market; it also allows either to forbid completely or to put under licensing the activity of the market participants, namely software and hardware developers, system integrators, providers, information technologies owners, advertisers, senders of uncolicited information services, and users.

The present invention allows purposive application of patent laws against spammers who break the law, as well as coordination of activities within IT industry, it also allows to expand the field of struggle against mass distribution of unsolicited information services, including commercial and non-commercial advertisements of goods and services, and it helps to find compromise between extremely stringent and too mild laws. For example, owners and senders of spam are citizens of one country, they send spam to users who live in another country, and servers of senders are placed in a different country as well. And it is not clear as to the laws of which country should be used to raise claims. However, all participants of spam market, whatever country they live in or send spam to, will automatically brake the author's right and the patent right of this invention.

The present invention will allow creation of a civilized and controlled market of visual, mail, communicational, tele-communicational, e-mail and other kinds of unsolicited advertisements and other uncolicited information services. This market will have prohibitions as well as effective mechanisms describing the way of how certain types of advertisements can and should be used and regulating processes within the Internet market.

The present invention, instead of using total war against spam, will allow stabilization of the spam market and organization of its participants, i.e. owners and senders of unsolicited information services, providers, users, anti-spammers, as well as establishment of the rules of the game taking into account participants' opinions and interests, for example, quotes on types and number of distributed uncolicited information services. Then spam will be put into a controlled channel and will become a civilized business instead of being enfant terrible of the modern Internet.

### BACKGROUND

In the traditional understanding, self promotion and marketing (spam) is impersonal, pseudo-personal or personal distribution of unsolicited mails, e-mails, calls or other messages to users or mass influence on users through the use of radio, television, telephone, IP telephony, mail, or the Internet by sending unsolicited e-mails or messages to those people who can become potential customers of commercial offers laid out in distributed messages. In case of impersonal greeting, it seems to the user that the visual, sound or mail message is addressed directly to him/her in order for him/her to put attention to the contents of the message. In general, spam has mass and anonymous character, and the effectiveness of its use in advertisements depends on the number of people who receive unsolicited information services. The majority of spam messages are of a commercial character. Nevertheless, it can be encouragement to get registered somewhere, or to vote for a certain person or item, or to do a test or fill out a form. Though it is not an advertisement, it is still kind of spam, under the stipulation that users have not subscribed to receive such mails, e-mails, calls or other messages.

Every day when reading a newspaper, watching TV, listening to the radio, using the Internet, looking through mail, or just going along the street, people constantly face mass commercial influence or “distribution” of inducing messages which they have not subscribed to. Spam is distributed by persons or legal entities, for example, advertising or PR agencies, companies or organizations that specialize in this field of activity. And the difference between distribution of unsolicited mails, e-mails, calls or other messages and legal distribution of advertisements and other information is very small or minimal.

Spam is the cheapest and the least accurate, yet extremely effective way of advertising and advertising drives all trade. Spam is the only chance for small business to present itself on the market. By providing information to potential customers, small companies enter competition with larger companies on the market and monopolies, and it is good for economy growth in general. That is why spam business is an effective, module, flexible and debugged mechanism and a living organism which is very hard to be controlled only by use of prohibitions or technical means on spam filtration, because the work of anti-spam servers often intervenes with the work of network, and some irresponsible actions of administrators can even block whole sub-networks which disrupts routes of message deliveries.

Present invention allows to struggle with infringers of the author's right by use of patent legislation, and prospective court hearings will impose great economic losses on senders and owners of span. Mass struggle against spam on legal and technical levels brings to its modification and creation of more complicated ways of mass distribution of unsolicited mails, e-mails, calls or other unsolicited information services. Laws on struggle against spam do not take account of many nuances; they prohibit and not regulate legal distribution. For example, a consumer can be accused of using an e-mail address mentioned in a TV commercial for sending a commercial offer of his/her company.

Present invention determines the legitimacy of actions of spam owners, advertisers and senders, taking into account negative results of passing laws on spam, for example, an attempt of global authentication of spam senders, which contradicts with the nature of the Internet which has conquered the world by introducing freedom and openness. Global registration of users is actually a global control of users, which will bring to closeness of the Internet, and this closeness will ruin the Internet.

In the present invention, mass distribution of unsolicited e-mails or unsolicited messages is used for two goals: distribution of advertisement and distribution of special viral software or links to infected users' computers or other Internet resources or services.

Present invention allows forming a new principle of the author's right “The one who is copied the most, must receive more money”. Such rule should encourage copying of information, and not forbid it.

### SUMMARY OF THE INVENTION

In the present invention, self promotion and marketing (spam) is any mass influence on people by use of visual, sound, or verbal messages of commercial character, or any mass distribution of information services or other commercial messages and letters, including all correspondence of commercial or non-commercial character which the user has not subscribed to and which encourages the user to buy goods or services from spam owners or third parties.

In the present invention, there are three main participants of the spam market: spam owner or advertiser who orders mass influence or mass distribution of commercial messages containing contact details and expects feedback from potential clients; spam sender who provides spam service and performs mass distribution; user or recipient of spam messages. Spam sender, advertiser and spam owner can be represented by the same person.

The present invention has the following advantages:

cheap distribution, which cost constantly decreases. For example, at the moment the cost of distribution of 1 million of unsolicited information services is less than 1 dollar. Tele-communicational networks, the Internet in particular, are a very cheap way of distribution of unsolicited e-mails or unsolicited messages, especially when the distribution uses users' resources, for example, users' computing powers which are accessed and administrated remotely.

high speed of delivery has an instant effect which can't be obtained by use of other commercial technologies.

minimum threshold of entering the market.

access to wide scope of potential customers for goods and services.

high effectiveness for owners and senders of unsolicited information services, or persons, or legal entity attributes. Minimum costs and maximum effectiveness raise stable and growing interest for this way of mass distribution of unsolicited information services, which feedback reaches, according to different estimations, 1-3%; and the average cost of attracting 1 customer is about $1-2. Thus, having paid a modest sum of money of about $100 for distribution of 1 million of uncolicited c-mails or uncolicited messages, the spam owner instantly gets hundred responses from potential customers for his/her goods and services.

In the present invention, mass influence on users and mass distribution of unsolicited information services or other unsolicited person's or legal entity's attributes is performed by owners themselves or through senders by use of visual, sound, communicational, tele-communicational or other ways of distribution, which provides growth of demand for owners' goods, services, or other person's or legal entity's attributes.

In the present invention, owners, senders and users are persons or legal entities, which can live either in the same country or in different countries and, moreover, owners and senders of unsolicited information services distribution can be the same persons or legal entities, and information distribution through unsolicited information services can be performed from hidden, anonymous or real addresses of senders with the use of real or false names of senders, or it can be done from senders' addresses that use pseudonyms to real users' addresses or to users' addresses which use anonymous pseudonyms.

In the present invention, unsolicited information services or other unsolicited person's or legal entity's attributes comprise tangible or intangible information services or other unsolicited person's or legal entity's attributes of advertising, commercial, non-commercial, impersonal, pseudo-personal, or personal character, for example, unsolicited mails in the form of letters, post cards, musical cards, newspapers, magazines, brochures, leaf lets; unsolicited radio or TV programmes, announcements, video clips; unsolicited telephone calls or fax messages; unsolicited Internet correspondence in the form of e-mails, messages; unsolicited visual information services placed on posters, stands, pictures, screens, monitors and other fixed or portable visual media of unsolicited information services.

In the present invention, unsolicited information services or other unsolicited person's or legal entity's attributes of personal character are masked as “ordinary” advertising messages in the form of usual greetings written in a free and friendly way with numerous spelling mistakes, which aim is to make the user click the URL out of curiosity and to convince the user that the message was sent by a friend and it was not spam. Unsolicited information services of pseudo-personal character often contain adjectives which are broadly used in traditional commercials and are combined with the person's name, using the user's log-in as his name, for example, <<Good morning Ufo>>. Unsolicited information services of impersonal character are written in the form of press releases and graphic files.

In the present invention, influence on users is performed by use of mass or individual, constant or periodic, multiple or single, manual or automatic distribution of unsolicited information services or other person's or legal entity's attributes.

In the present invention, mass influence on users or mass distribution of unsolicited information services is performed by visual, sound, mail, communicational, tele-communicational and other ways through radio, TV, the Internet, printers or other peripheral devices, smart phones, cable or mobile telephones, fax, IP telephony or other tangible or intangible media of impulsive unsolicited information services, which increases mail, phone, tele-communicational or other traffic and raises demand for goods, services or other person's or legal entity's attributes.

In the present invention, mass influence on users or mass distribution of unsolicited information services is performed by use of visual, sound, or mail ways of distribution when sending unsubscribed correspondence, for example, letters, post cards, musical cards, newspapers, magazines, brochures, leaflets, or other tangible forms of impulsive information services, which increases mail traffic and raises demand for goods and services.

In the present invention, mass influence on users or mass distribution of unsolicited information services is performed by visual, sound, mail, communicational ways by use of verbal or gestural means, for example, songs, gestures, pantomime, mimics or other impulsive means, which increases human traffic and raises demand for goods and services.

In the present invention, mass influence on users or mass distribution of unsolicited information services is performed by visual, sound, tele-communicational ways by use of fixed stands, posters, screens, displays, monitors, and other visual fixed or portable media of information services placed on vehicles, streets, squares and other public places, or other visual or sound media of impulsive information services, which increases human traffic and raises demand for goods and services.

In the present invention, mass influence on users or mass distribution of unsolicited information services is performed by sound, tele-communicational ways by use of radio and other sound media of impulsive information services, which increases human traffic and raises demand for goods and services.

In the present invention, mass influence on users or mass distribution of unsolicited information services is performed by visual, sound, tele-communicational ways by use of TV and other visual sound or tele-communicational media of impulsive information services, which increases human traffic and raises demand for goods and services.

In the present invention, mass influence on users or mass distribution of unsolicited information services is performed by visual, sound, tele-communicational ways by use of cable or mobile telephone and fax, for example, distributing unsolicited SMS manually, through remote administration of SMS-gates operators of mobile connection in the Internet, through operators who advertise their services, or other tele-communicational media of impulsive information services, which increases phone traffic and raises demand for goods and services.

In the present invention, mass influence on users or mass distribution of unsolicited information services is performed by visual, sound, tele-communicational ways by use of mobile telephone Bluetooth-technology, for example, launching special software, such as Blue-bugging, on personal computers which are equipped with special devices and antennas for detecting mobile telephones and giving them orders to do optional unsolicited calls to optional users' addresses.

In the present invention, mass influence on users or mass distribution of unsolicited information services is performed by visual, sound, tele-communicational ways by use of mobile telephone Bluetooth-technology, for example, launching special software, such as blue-snarfing, which detect unprotected mobile telephones, copy all address books, calendars, pictures and other information from these telephones, and then send optional unsolicited messages from these telephones to optional users' addresses.

In the present invention, mass influence on users or mass distribution of unsolicited information services is performed by visual, sound, tele-communicational ways through the Internet by sending unsolicited e-mails or unsolicited messages, for example, through instant messaging (IM) service, mobile instant messaging (MIM) service, MSN service or by using other Internet based impulsive technologies, which increases Internet traffic and raises demand for goods and services.

In the present invention, mass influence on users or mass distribution of unsolicited e-mails or unsolicited messages is performed through the Internet by using special software for remote administration of users' resources or by using various browsers, which enables gathering of users' e-mail addresses and distribution of unsolicited e-mails or unsolicited messages to these addresses.

In the present invention, mass influence on users or mass distribution of unsolicited e-mails or unsolicited messages to users is performed through the Internet following a certain algorithm (technological cycle) of actions performed independently from each other in any order and any combination, i.e.: gathering of e-mail addresses and creation of database of users' addresses; verification of users' addresses; classification of users' addresses according to certain types; preparation of distribution centers (computers) which will be used for distribution of unsolicited e-mails or unsolicited messages; development of special software for distribution of unsolicited e-mails or unsolicited messages; clients search; creation of contents for unsolicited e-mails or unsolicited messages; distribution of unsolicited e-mails or unsolicited messages.

In the present invention, participants of the spam market can gather e-mail addresses and create databases by scanning web-pages in the Internet with the help of special automatic programmes-robots which gather users' e-mail addresses of certain types, for example, user@domain.name, then sort them out according to their specifics, geographical or quantity criteria, for example, corporative addresses such as user@company.com, or free public server addresses like user@yahoo.com, user@hotmail.com, user@mail.ru, etc., and then create common databases of e-mail addresses which are constantly updated and several topical databases of e-mail addresses which can be used by participants of the spam market either for mass distribution of unsolicited e-mails or unsolicited messages or for sale to other participants of the market.

In the present invention, participants of the spam market can gather e-mail addresses and create databases of anonymous mail servers by scanning web-pages in the Internet with the help of special automatic programmes-robots that gather e-mail addresses of the anonymous mail servers, which are used by the automatic programmes-robots for test mail distribution, and create constantly updated common databases of these anonymous mail servers which can be used by participants of the spam market either for mass distribution of unsolicited e-mails or unsolicited messages or for sale to other participants of the market.

In the present invention, senders of mass distribution of unsolicited e-mails or unsolicited messages prepare commercial e-mails or messages, then either download from the Internet, buy or develop themselves special software for mass distribution, adjust the software by uploading databases of e-mail addresses, and finally launch the programmes to perform mass distribution of unsolicited e-mails or unsolicited messages.

In the present invention, all chains and modules of the technological cycle of the spam business can function independently from each other or can be combined in any order, for example, senders, professional spam companies can combine all these stages starting from gathering of e-mail addresses and creation of databases and up to distribution of unsolicited e-mails or unsolicited messages to the gathered addresses or sale of this information to other participants.

In the present invention, senders modify texts and titles by using special software, which makes distributed unsolicited e-mails or unsolicited messages look unique, for example, messages can contain different text, title, or sender's address.

In the present invention, senders of mass distribution of unsolicited e-mails or unsolicited messages send small portions of e-mails or messages to themselves first, till at least one message successfully brakes all spam filters, and then they perform mass distribution of this message to users as quickly as possible.

In the present invention, mass distribution of unsolicited e-mails or unsolicited messages is performed through the Internet individually to each consumer in the form of personalized unsolicited messages which contain some differences in the text, for example, <<Hello, Gym!>> in the beginning of the message sent to the address Gym@user.com or Gym@company.com, or which allow input of information from any fields of the list for distribution, as well as dynamic changes in the message contents, depending on the condition of the fields of the list for distribution.

In the present invention, mass distribution of unsolicited e-mails or unsolicited messages is performed through the Internet by open relays of mail servers, which enables distribution of optional unsolicited e-mails or unsolicited messages to optional users' addresses.

In the present invention, mass distribution of unsolicited e-mails or unsolicited messages is performed through the Internet from modem pools by use of providers' mail servers which receive e-mail messages from their users and then forward them to other users.

In the present invention, mass distribution of unsolicited e-mails or unsolicited messages is performed through the Internet by using dial-up connections and receiving a lot of dynamic IP-addresses which are changed after each connection and are used for distribution of unsolicited e-mails or unsolicited messages.

In the present invention, mass distribution of unsolicited e-mails or unsolicited messages is performed through the Internet by changing routes of unsolicited e-mails or unsolicited messages delivery to users, for example, by changing IP-addresses of several last used open relays.

In the present invention, mass distribution of unsolicited e-mails or unsolicited messages is performed through the Internet from users' computers which have been remotely equipped with unsolicited special software, for example, software of file, downloading, network, bodiless or combined type, which is capable of spreading independently in the computer network and gives senders of unsolicited e-mails or unsolicited messages a possibility to remotely administrate users' computer resources without their awareness and control. Moreover, the special software can spread together with unlicensed software within file-exchange networks, for example Kazaa, eDonkey, they can also spread using vulnerabilities in different versions of Windows and other special software, for example, MSIE, MS Outlook, or Downloader, which are used for installation of special software on users' computers providing remote access and administration of these computers.

In the present invention, distribution of punsolicited e-mails, messages or other information services to users is performed through the Internet by use of special software for example, Firefox, Internet Explorer or other web-browsers, which provide remote access, control and administration of network's printers, with the opportunity for printers to perform unsolicited actions, for example, starting printing of unsolicited advertisements (cross-site printing), sending of unsolicited faxes, formatting hard disc, uploading of special software.

In the present invention, mass distribution of unsolicited e-mails or unsolicited messages is performed through the Internet by remote access, installation and launching of special software, such as Downloader, on users' computers, which, after having been installed, connects to the owners' servers and sends information about installation with details of IP-addresses on the users' computers where they have been installed, as well as details of characteristics and certain unique identifications. In response they receive configurations containing URL addresses of those servers which will be used for downloading lists of e-mail addresses and templates. Then this special software is used for downloading databases with e-mail addresses and templates and distribution of unsolicited e-mails or unsolicited messages, modifying texts, adding pictures to messages or transforming text messages into graphic messages in accordance with set algorithms and templates. After a certain portion of unsolicited e-mails or unsolicited messages have been distributed, the special software is used for sending reports on the performed work to the owners, and the reports may contain statistical data, for example, a number of successful distributions and mistakes, and a list of addresses to which the messages could not be distributed.

In the present invention, participants of the spam market create products for sale to other participants of the spam market in the form of special software, special software networks, or the processes of distribution of unsolicited e-mails or unsolicited messages.

In the present invention, mass distribution of unsolicited c-mails or unsolicited messages is performed through the Internet either by use of different protocols for distribution of unsolicited e-mails or unsolicited messages to users, for example, Sender ID or SPF protocols, or by use of special software or utilities containing databases with users' addresses, or by use of incorrectly configured mail servers, or by use of web-interfaces of mail servers, or by use of incorrectly configured proxy servers which receive unauthorized inquiries from optional IP-addresses, for example, IP-addresses of ADSL users who have built-in SOCKS-servers or HTTP proxy servers which enable remote control and administration of users' computers.

In the present invention, mass distribution of unsolicited e-mails or unsolicited messages is performed through the Internet by use of special Proxy software which opens certain TCP ports with static or optional numbers of ports for run-through; after that Proxy software connects to the owners and sends them IP addresses and numbers of TCP ports, and then this software works as ordinary proxy servers.

In the present invention, mass distribution of unsolicited e-mails or unsolicited messages is performed through the Internet by creating specialized “zombie”-networks out of Proxy servers, which could perform mass distribution, or through IRC-servers (Internet Relay Chat) or through web-pages retransmitting orders for mass distribution to all computers of the “zombie”-network, which perform mass distribution of unsolicited e-mails or unsolicited messages.

In the present invention, mass distribution of unsolicited e-mails or unsolicited messages is performed through the Internet by applying full random of data or any parameters of e-mails or messages containing random texts, hidden texts or “noises”, for example, an abstract from a classical book or just random set of words can be put in the beginning or in the end of a letter, or HTML messages can contain texts that are “invisible” to users of the pages and are indexed by search machines, for example, a text written in a very small print in 1 pixel, or blocks of texts either in style <<display: none>> or in color of the background.

In the present invention, mass distribution of unsolicited e-mails or unsolicited messages is performed through the Internet by use of graphic files, for example, files containing 3D graphic images “diluted” with colored dots or lines which distort text or contain text written using different fonts and different prints, which creates a 3D image.

In the present invention, mass distribution of unsolicited e-mails or unsolicited messages is performed through the Internet by use of files with animation consisting of several shots, one of which is dominant, conveys the main message, and it can be shown for a longer time than other shots which are just part of the background containing different picture elements that are not meaningful. Or it can be performed by use of files with animated graphics, for example, GIF animation.

In the present invention, mass distribution of unsolicited e-mails or unsolicited messages is performed through the Internet by use of 3D graphic images with text unique to every user, for example, uniquely generated images that are part of unsolicited e-mails or unsolicited messages sent in PDF and FDF formats for Adobe Acrobat.

In the present invention, mass distribution of unsolicited e-mails or unsolicited messages is performed through the Internet by use of simple text messages with the same contents or paraphrased texts, for example, the same message has a lot of different versions of the same text.

In the present invention, mass distribution of unsolicited e-mails or unsolicited messages is performed through the Internet by use of special scripts that compare users' IP-addresses with address databases of search robots and perform analysis of query variables, when the site contents in its optimized version is shown to the search machine, while the normal web-page is shown to the user, and the latter is different from the former, for example, a server identifies user's IP-address according to geographical criteria and shows him/her the web-page in his/her native language.

In the present invention, mass distribution of unsolicited e-mails or unsolicited messages is performed through the Internet from unlimited number of sites or e-mail addresses created by using unlimited number of new domain names or e-mail addresses, where any letter or number, except for the first and the last one, in any word may be changed to <<hyphen>>, <<dot>> or <<@>>. For example, the change of letter <<a>> to <<hyphen>> in the word <<spam>> gives a new domain name of the second level <<sp-am.com>>, and the change of letter <<a>> to <dot>> in the word <<spam> gives a new domain name of the third level (sub-domain) <<sp.am.com>>. For example, the change of letter <<a>> to <<@>> in the word <<spam>> gives a new e-mail address <<sp@am.com>>.

In the present invention, mass distribution of unsolicited e-mails or unsolicited messages is performed through the Internet by adding extra spaces in users' e-mail addresses and changing @ to “at”, and a dot to “dot”, for example, the address “john@hotmail.com” can be changed to the address “john (at) hotmail dot com”, or by deleting certain letters from users' e-mail addresses, for example, unsolicited e-mails or unsolicited messages are sent to the address john@hotmail.com instead of john-abracadabra@hotmail.com, or by putting the word <<staff>> into users' e-mail addresses, for example, staff@xxx.com, and in this case such messages go to the user's inbox.

In the present invention, mass distribution of unsolicited e-mails or unsolicited messages is performed through the Internet by mixing letters from different languages in users' e-mail addresses, for example, mixing letters from Russian and English alphabets, for example, “john “ [symbol] ” mail [symbol] py”, or by omitting ending in users' e-mail addresses, for example, “john @mail [symbol] [symbol] , [symbol] [symbol] ”.

In the present invention, mass distribution of unsolicited e-mails or unsolicited messages is performed through the Internet from a lot of either own or rented hidden addresses or real addresses of senders under real or false names in different languages and with different speed, intervals, frequency and duration of distribution, for example, performing mass distribution of a large number of repeated unsolicited e-mails or unsolicited messages during one day with further break in the distribution or full completion of the distribution, or performing mass distribution of unsolicited e-mails or unsolicited messages in between the periods of update of users' protecting programmes.

In the present invention, mass distribution of unsolicited e-mails or unsolicited messages is performed through the Internet, where unsolicited e-mails or unsolicited messages contain formal characteristics of distribution, which allows users and providers to distinguish between different topics of unsolicited e-mails or unsolicited messages, for example, signatures in e-mails or messages showing certificates of the provider; or unsolicited e-mails or unsolicited messages contain special typical notes in the subject of the message indicating its commercial character, for example, identifier <<ADV>> (advertisement) or other special identifiers in the subject of unsolicited e-mails or unsolicited messages, for example, notes <<ADLT>> (adult); or unsolicited e-mails or unsolicited messages contain warnings that the message is unsolicited advertisement.

In the present invention, mass distribution of unsolicited e-mails or unsolicited messages is performed through the Internet, where unsolicited e-mails or unsolicited messages do not have distinct contents, they are unclear, contradictory and do not provide proof of their authenticity in the following distribution of unsolicited e-mails or unsolicited messages which explain the contents of the previous messages.

In the present invention, mass distribution of unsolicited e-mails or unsolicited messages is performed through the Internet by creating memory for distribution of every unsolicited e-mail or unsolicited message, for example, creating cryptographic electronic “stamp” or stamp of approval.

In the present invention, mass distribution of unsolicited e-mails or unsolicited messages is performed through the Internet by use of special software simultaneously from a lot of IP addresses to a certain chosen IP address, which provides increase in network traffic to the level that brings partial of full blockage of other users' access to this IP address.

In the present invention, mass distribution of unsolicited e-mails or unsolicited messages is performed through the Internet by designing web-sites that contain popular phrases or word combinations, for example, keywords, description, or sex, porno, which are not present in the contents of web-pages; or web-sites that contain key words which are repeated in search queries for a certain number of times; or web-sites that contain invisible text and tiny text; or by redirecting users to other web-sites, for example, using meta tags refresh or Java scripts.

In the present invention, mass distribution of unsolicited e-mails or unsolicited messages is performed through the Internet by designing and promoting in the search index an unlimited number of special Internet doorway pages which are set to meet certain search criteria and provide increase of weight of a certain web-page in link ranking, when links are redirected to a certain web-page, which allows increase in link popularity and Page Rank of the sites in search results. Then these doorway pages are registered in a lot of topical catalogues with links to the main site, or links can be exchanged or bought, including getting links from quest books, forums, blogs, wiki, and automatically generated blogs (splogs) can be created and used.

In the present invention, mass distribution of unsolicited e-mails or unsolicited messages is performed through the Internet by designing another doorway page (when due to certain reasons it is impossible to change the code of the page) on the same domain or another one with the contents that has no meaning to users but contains a great number of key words which are used for hidden redirection to the main page. Then this doorway page is promoted and put on the top of search queries. And when a user, following a link from the search query, enters the doorway page, he/she is automatically redirected to the main page.

In the present invention, mass distribution of unsolicited e-mails or unsolicited messages is performed through the Internet by designing and automatically generating doorway pages in big numbers; then these pages are indexed in search systems, and the main site continues to receive additional traffic from these doorway pages for a certain period of time.

In the present invention, mass distribution of unsolicited e-mails or unsolicited messages is performed through the Internet by mutual exchange of data, when traffic from search machines goes one way, and the contents of unsolicited e-mails or unsolicited messages goes the opposite way. This process is ensured by certain infrastructure which includes operators that provide access to site contents making them available for further use, as well as operators that provide gathering of information in big volumes, including domains redirection system which provides redirection to doorway-pages.

In the present invention, mass distribution of unsolicited e-mails or unsolicited messages is performed through the Internet by moving from looking through advertisements on customers' (advertisers') sites, where the contents of unsolicited e-mails or unsolicited messages follows the reverse scheme and goes back to operators who give access to site contents enabling further use of the sites, further to operators who gather information in mass volumes, and further redirection to doorway-pages using domains redirection system, when the traffic of search machines goes the way opposite to movement of contents of unsolicited e-mails or unsolicited messages. Then the process of mutual exchange of data can be started in the opposite way following the reverse order.

In the present invention, the following parties participate in the process of mutual exchange of data: doorway pages system; domains redirection system; operators (sites) that gather information in mass volumes; operators that provide access to contents of the sites which are available for further use; customers (advertisers).

In the present invention, the aim of this mutual exchange of data is users' redirection to customers' (advertisers') web-sites in the result of search queries, for example, by pressing the mouse button. After the button has been pressed, the domains redirection system starts working and initiates the process which gives access to contents of the sites and provides opportunity for their further use, which results in users' redirection to customers' (advertisers') web-sites.

In the present invention, the process of mutual exchange of data can be carried out in closed cycle by moving from looking through advertisements on customers' (advertisers') sites to operators who give access to site contents enabling further use of the sites, further to operators who gather information in mass volumes, and further to doorway-pages using domains redirection system, and then to opposite process can be started by pressing the mouse button.

In the present invention, unsolicited e-mails or unsolicited messages have impulsive character and they can have influence on securities price, for example, price of certain stock that are turned on the off-exchange market in electronic trade systems which encourage users to buy securities from customers (advertisers), senders or third parties for overcharge and sell them for under price (pump and dump).

In the present invention mass distribution of unsolicited e-mails or unsolicited messages is performed through the Internet according to the following algorithm of actions: senders perform mass and multiple distribution of unsolicited e-mails or unsolicited messages of different character, which brings to increase in network traffic and partial or full blockage of access to users' servers; senders repeat mass distribution of unsolicited e-mails or unsolicited messages containing offers to stop mass distribution for a certain price, for example 1$, and details of bank accounts for payment transfers; after the noted payments have been made by users to the noted bank accounts, senders stop mass distribution to these users' addresses either temporarily, or partially, or fully.

In the present invention, mass distribution of unsolicited e-mails or unsolicited messages is performed through the Internet by use of special software which creates potentially feasible e-mail addresses, for example, by using all possible combinations of letters and numbers or using lists of popular names in e-mail addresses consisting of initials, and distributing unsolicited e-mails or unsolicited messages to these addresses. Distribution to non-existing addresses is stopped, and the rest of the addresses are considered to be existing, they are included in databases of e-mail addresses and are used for further mass distribution which brings to increase in network traffic and partial or full blockage of access to users' servers.

In the present invention, mass distribution of unsolicited e-mails or unsolicited messages to users is performed through the Internet, when the distribution is performed by senders from real addresses under their own names till the moment when they receive a note from users (for example, from real addresses located in USA) saying that the users do not wish to receive the distribution (opt-out), for example, in the form of a request or notification about stopping the distribution performed, for example, by post, telephone, fax, orally or by e-mail, for example, letters containing a line to “unsubscribe” which is placed in any part of the message, for example, in the bottom, and allowing users to unsubscribe from the distribution of certain types of messages or services, for example, if a user is unsubscribed from the advertisement of Y-Box, he/she may still receive updates relating to Windows security.

In the present invention, mass distribution of unsolicited e-mails or unsolicited messages is performed through the Internet from constantly appearing new senders, for example, from new persons or newly established legal entities, for example, new companies established on a daily basis; as a result, in spite of daily unsubscribing from distribution, users continue to receive unsolicited information services on a daily basis, for example, through the use of “partner” programmes, when the same information services are offered by a number of different senders, and users send requests for being unsubscribed to every sender separately.

In the present invention, mass distribution of unsolicited e-mails or unsolicited messages is performed in such a way, that new senders are added more quickly than users can unsubscribe from distribution of unsolicited e-mails or unsolicited messages. In this case users are not able to physically unsubscribe from a big number of senders and continue to receive great amounts of unsolicited e-mails or unsolicited messages.

In the present invention, mass distribution of unsolicited e-mails or unsolicited messages is performed through the Internet to those users who had pre-existing business relationship with senders, and users have choice to unsubscribe from receiving unsolicited e-mails or unsolicited messages.

In the present invention, mass distribution of unsolicited e-mails or unsolicited messages is performed through the Internet from a definite anonymous address, for example, anonymous@everywhere.com or anonymous@nowhere.com, which gives users opportunity to filter distribution according to certain criteria and place it in separate folders.

In the present invention, mass distribution of unsolicited e-mails or unsolicited messages is performed through the Internet by using systems with substitution of synonymous symbols, IP addresses virtualization and substitution of artificial symbols into service fields of mail servers.

In the present invention, mass distribution of unsolicited e-mails or unsolicited messages is performed through the Internet by use of special software which allows using an infected user's computer in such a way, that all distribution of unsolicited e-mails or unsolicited messages goes through the mail server of the provider to which the infected user's computer is connected to, and infected computer itself does not distribute anything to new potential users.

In the present invention, mass distribution of unsolicited e-mails or unsolicited messages is performed through the Internet by use of distributed remote terminal sessions, for example, through terminal servers in Windows 2000, allowing remote administration of users' computers and control of users' sessions, for example, using function <<remote control>> and changing settings of RDP-connections, using ‘Terminal Services Configuration’ MMC snap-in.

In the present invention, mass distribution of unsolicited e-mails or unsolicited messages is performed through the Internet by remote launching of special software on users' computers, which allows their remote control and administration using applications Microsoft Excel and Power Point, for example Office 97, Office XP, which have special function for document checking, which, every time when a document is opened, shows warning to the user to disable automatic use of macros if they seem to be dangerous; and remote launching of special software for remote administration of users' computers is performed immediately after a document is opened in any of these applications.

In the present invention, mass distribution of unsolicited e-mails or unsolicited messages is performed through the Internet by installing universal utilities on users' computers, such as Pinch, which creates special self-reproducing software for remote administration of users' computers or turning them into proxy-servers for distribution of unsolicited e-mails or unsolicited messages.

In the present invention, the most popular topics of unsolicited e-mails or unsolicited messages are the following: Health services (offers of medicine, viagra, goods and services for keeping health, methods of loosing weight, etc.); Education (courses of foreign languages, seminars, business seminars, conferences, trainings, etc.); The Internet (offers of unlicensed software, goods and services through the Internet, offers of databases with users' addresses, etc.); Business and Finance (earning money, taking cash, putting investments, buying-selling shares, establishing business); Services (legal services, accounting services, tourism services, construction services, domestic services); Dating (dating, porno, sex, etc.).

The present invention allows access to this special folder <<Advertisement>> for each user. And in this case, the user will see this folder as his/her own folder, designated only for reading, and while reviewing its content the user can download letters' headlines or the field <<Subject>> of the unsolicited e-mails or unsolicited messages, which allows minimizing traffic. Thus, all unsolicited e-mails or unsolicited messages in this folder can be deleted automatically, for example, after a certain period expires, for example, after 30 days.

The present invention allows senders and users to have official channel for advertising and distribution of unsolicited e-mails or unsolicited messages, without using special software, for example, bot-networks, which are used for spam distribution. Each user will have right to read all unsolicited e-mails or unsolicited messages, if he/she finds it necessary, as well as to get news and advertisements. Apart from that, each user gets an opportunity to distribute his/her own advertisements and to reach all users of this server.

### BRIEF DESCRIPTION OF THE DRAWINGS

FIG. 1 is a comprehensive block diagram, showing general organizational structure of the process of mass influence on users or mass distribution of unsolicited information services to users.

FIG. 2 is a comprehensive scheme, showing detailed organizational structure of the process of mass influence on users or mass distribution of unsolicited information services to users.

FIG. 3 is a comprehensive block diagram, showing the algorithm of actions on organizing mass distribution of unsolicited information services in a tele-communicational way through the Internet (action 1, 2, 3, 4, 5, 6, 7, 8).

FIG. 4 is an example, showing the process of mass distribution of unsolicited information services in a tele-communicational way through the Internet by use of special software, for example, Downloader, which enables remote access and administration of users' computers.

FIG. 5 is an example showing the process of mass distribution of unsolicited information services in a tele-communicational way through IRC servers by use of special software, for example, Proxy-Server, which enables remote access and administration of users' computers.

FIG. 6 is a comprehensive scheme explaining the field of application for the present invention.

### DETAILED DESCRIPTION OF THE PREFERRED EMBODIMENT

Next, with reference to the accompanying drawings, a business method for self promotion and marketing according to an embodiment of the present invention will be described.

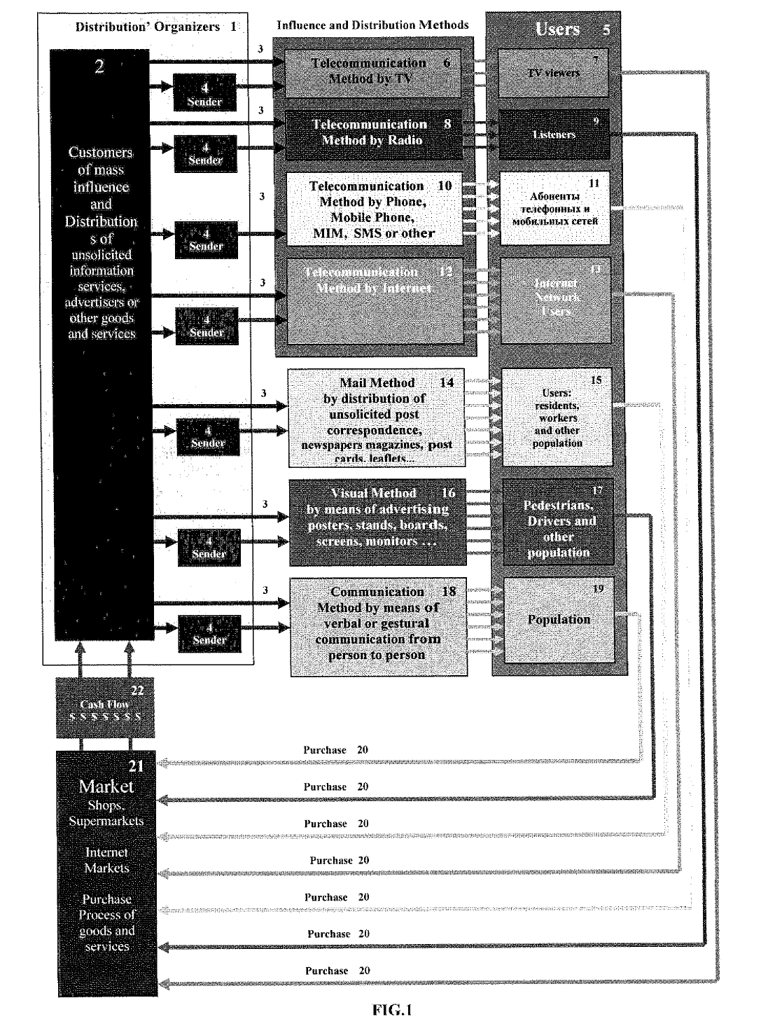

FIG. 1 is a block-diagram showing comprehensive organizational structure of the business process of self promotion and marketing according to an embodiment of the present invention will be described.

FIG. 1 shows and explains the process of self promotion and marketing, performed by use of mass influence of unsolicited information services on users or by mass distribution of unsolicited information services to users from organizers 1 of mass distribution, i.e.: from customers (advertisers) 2 (blue marked), who can produce mass influence and perform mass distribution either themselves 3 (blue arrows), or using services of senders 4 (brown marked). Mass influence of unsolicited information services on users 5 or mass distribution of unsolicited information services to users 5 can be performed in a tele-communicational way 6, 8, 10, 12, by mail 14, in a visual way 16, in a communicational way 18, or in other ways.

FIG. 1 shows and explains the process of mass influence of unsolicited information services on users, performed in a tele-communicational way through TV 6 on audience 7. When watching TV programmes, audience 7 are exposed to constant influence of unsolicited information services and advertisements of different goods and services in the form of commercial clips, breaks, video clips, and other unwanted and disturbing unsolicited information services.

FIG. 1 shows and explains the process of mass influence of unsolicited information services on users, performed in a tele-communicational way through Radio 8 on listeners 9. While listening to radio programmes, listeners 9 are exposed to constant influence of unsolicited information services and advertisements of different goods and services in the form of commercial announcements and other unwanted and disturbing unsolicited information services.

FIG. 1 shows and explains the process of mass influence of unsolicited information services on users and mass distribution of unsolicited information services, performed in a tele-communicational way through Phone, Mobile Phone, IP phone, Faximile services 10 to users 11 of cable telephone and mobile phone connection. Users 11 of cable telephone and mobile phone connection are exposed to constant influence of unsolicited information services and advertisements of different goods and services in the form of phone calls, SMS messages, and other unwanted and disturbing unsolicited information services.

FIG. 1 shows and explains the process of mass distribution of unsolicited information services, performed in a tele-communicational way through the Internet 12 to users 13 of the Internet. Users 13 of the Internet are exposed to constant influence of unsolicited information services and advertisements of different goods and services in the form of mass distribution of unsolicited e-mails, and other unwanted and disturbing unsolicited information services.

FIG. 1 shows and explains the process of mass distribution of unsolicited information services to users, performed by mails 14, through distribution of unsolicited mails, letters, newspapers, magazines, post cards, leaf lets, which are put in mail boxes of users' 15, i.e.: people in cities, towns, villages, countryside, houses, apartments, as well as employees of different companies, state organizations and other enterprises. Users 15 are exposed to constant influence of unsolicited advertisements of different goods and services that comes to them in the form of unwanted and disturbing unsolicited commercial mail, letters, newspapers, magazines, post cards, and leaf lets.

FIG. 1 shows and explains the process of mass influence of unsolicited information services, performed in a visual way 16 on users 17 (pedestrians, drivers, and other people), through the use of commercial stands, boards, posters, screens, monitors put either on moving vehicles or fixed in public places, either inside or outside. Users 17 are exposed to constant influence of unsolicited advertisements of different goods and services that is put on stands, boards, posters, screens, monitors, and other means of unwanted and disturbing visual influence.

FIG. 1 shows and explains the process of mass influence of unsolicited information services on users, performed in a communicational way 18 using verbal or gestural means, on people 19 either orally or in writing from one person to another. Some people are exposed to constant influence from other people who advertise unsolicited impulsive goods and services in public places, or in small companies of friends, or one-by-one. Such influence also has unwanted and disturbing character.

FIG. 1 shows and explains the comprehensive process of buying 20 goods, services, and other products on the market 21 by users 5 (buyers) and movement of money 22 (cash flow) from buyers 7, 9, 11, 13, 15, 17, 19 to organizers of mass distribution 1, i.e.: advertisers 2 and senders 4, which closes a full technological spam cycle.

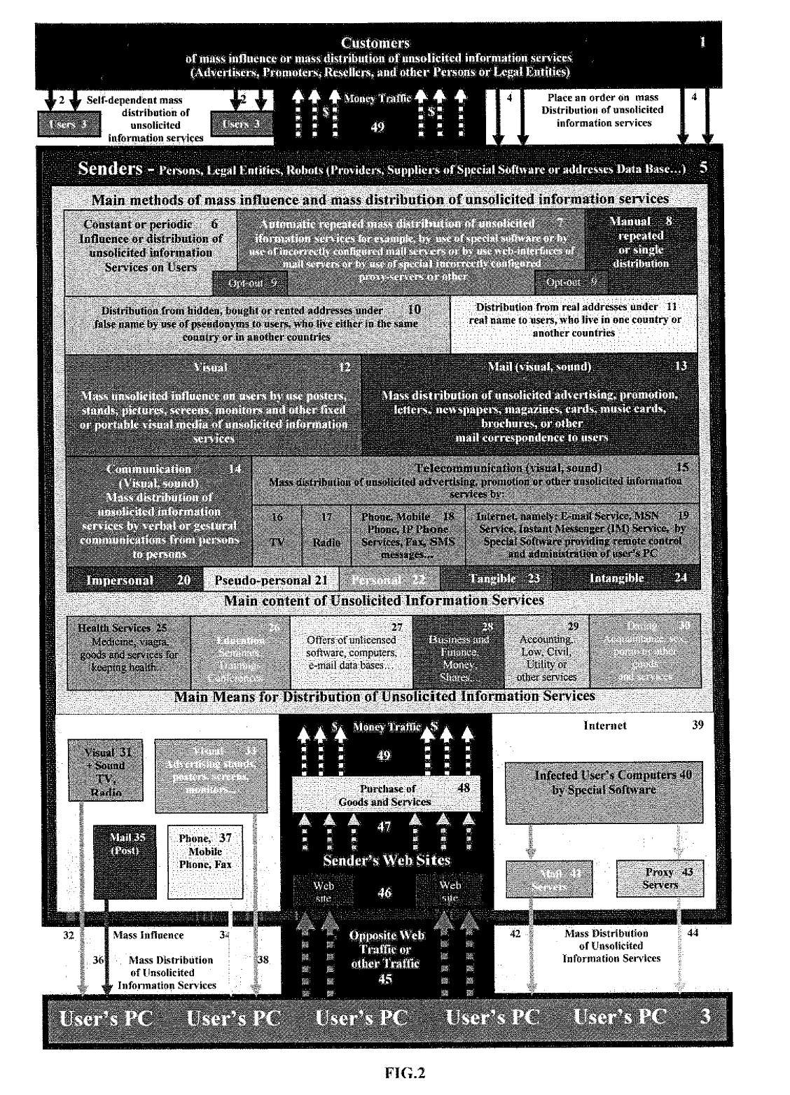

FIG. 2 is a block-diagram showing a detailed organizational structure of the business process of self promotion and marketing according to the embodiment of the present invention which will be described.

FIG. 2 shows and explains the process of self promotion and marketing, performed by use of either mass influence of unsolicited information services on users, or mass distribution of unsolicited information services to users from organizers of the distribution, i.e. advertisers 1, who perform mass distribution to users 3 themselves 2, or place orders 4 for mass distribution of unsolicited information services to senders 5. Customers (Advertisers) 1 are advertisers, promoters, resellers or other persons or legal entities. Senders 5 are providers, suppliers of special software or other persons or legal entities or robots.

FIG. 2 shows and explains the process of self promotion and marketing, wherein constant or periodic mass influence 6 on users 3 is performed through the use of either automatic 7 multiple mass distribution or manual 8 single or multiple mass distribution, as well as the use of function opt-out 9.

FIG. 2 shows and explains the process of self promotion and marketing, wherein mass influence on users 3 is performed through the use of mass distribution of unsolicited information services to users 3 under assumed names from hidden, bought or rented addresses 10, using pseudonyms, to users who live either in the same country or in different countries.

FIG. 2 shows and explains the process of self promotion and marketing, wherein mass influence on users 3 is performed through the use of mass distribution of unsolicited information services to users 3 under real names from real addresses 11, to users who live either in the same country or in different countries.

FIG. 2 shows and explains the process of self promotion and marketing, wherein mass influence of unsolicited information services on users 3 is performed in a visual way 12 through the use of fixed or mobile stands, posters, screens, monitors, and other fixed or mobile means of advertisement, or advertisement placed in public places either inside or outside.

FIG. 2 shows and explains the process of self promotion and marketing, wherein mass influence of unsolicited information services on users 3 is performed by mail 13 through the use of mass distribution of unsolicited letters, newspapers, post cards, musical cards, leaflets, brochures, or other mail advertising, promotion, reselling, or other mail correspondence.

FIG. 2 shows and explains the process of self promotion and marketing, wherein mass influence of unsolicited information services on users 3 is performed by communicational way 14 through verbal or gestural communications from person to person.

FIG. 2 shows and explains the process of self promotion and marketing, wherein mass influence of unsolicited information services on users 3 is performed by tele-communicational way 15 through TV 16.

FIG. 2 shows and explains the process of self promotion and marketing, wherein mass influence of unsolicited information services on users 3 is performed by tele-communicational way 15 through Radio 17.

FIG. 2 shows and explains the process of self promotion and marketing, wherein mass influence of unsolicited information services on users 3 is performed by tele-communicational way 15 through phone, mobile phone, fax, SMS messages or IP phone services 18.

FIG. 2 shows and explains the process of self promotion and marketing, wherein mass influence of unsolicited information services on users 3 is performed by tele-communicational way 15 through mass Internet distributions 19, namely: by e-mails service, MSN service, Instant Messenger (IM) service or by special software, providing remote control and administration of user's computers.

FIG. 2 shows and explains the process of self promotion and marketing, wherein distributed unsolicited information services can be impersonal 20, pseudo-personal 21, or personal 22.

FIG. 2 shows and explains the process of self promotion and marketing, wherein distributed unsolicited information services can be tangible 23 or intangible 24.

FIG. 2 shows and explains the process of self promotion and marketing, wherein distributed unsolicited information services relate to the field of health protection 25 and can contain advertisements of medicines, viagra, and other goods and services related to health.

FIG. 2 shows and explains the process of self promotion and marketing, wherein distributed unsolicited information services relate to the field of education 26 and can contain advertisements of seminars, trainings, conferences, diplomas, and other goods and services.

FIG. 2 shows and explains the process of self promotion and marketing, wherein distributed unsolicited information services relate to the field of the Internet Service and can contain offers of unlicensed software, computers, e-mail data bases 27 or other goods and services.

FIG. 2 shows and explains the process of self promotion and marketing, wherein distributed unsolicited information services relate to the field of Business and Finance 28 and can contain offers of buying shares, earning money, or other goods and services.

FIG. 2 shows and explains the process of self promotion and marketing, wherein distributed unsolicited information services relate to the field of services 29 and can contain offers of accounting, legal, construction, or other services.

FIG. 2 shows and explains the process of self promotion and marketing, wherein distributed unsolicited information services relate to the field of dating 30 and can contain offers of dating, sex, porno, or other services.

FIG. 2 shows and explains the process of self promotion and marketing, wherein visual or sound mass influence 32 of unsolicited information services on users 3 is performed through TV or Radio 31.

FIG. 2 shows and explains the process of self promotion and marketing, wherein visual or sound mass influence 34 of unsolicited information services on users 3 is performed through the use of fixed or portable posters, screens, and monitors 33.

FIG. 2 shows and explains the process of self promotion and marketing, wherein visual or sound mass influence 36 of unsolicited information services on users 3 is performed through mass distribution of unsolicited mail 35.

FIG. 2 shows and explains the process of self promotion and marketing, wherein mass distribution of unsolicited telephone calls, fax or SMS messages 38 to users 3 is performed through phone, or mobile phone 37.

FIG. 2 shows and explains the process of self promotion and marketing, wherein mass distribution of unsolicited information services 42 to users 3 is performed through the Internet network 39 from infected user's computers 40 by special software through mail servers 41.

FIG. 2 shows and explains the process of self promotion and marketing, wherein mass distribution of unsolicited information services 44 to users 3 is performed through the Internet network 39 from infected user's computers 40 by special software through proxy servers 43.

FIG. 2 shows and explains the process of self promotion and marketing, wherein opposite web traffic 45 or other traffic goes from users 3 to sender's web sites 46.

FIG. 2 shows and explains the process of self promotion and marketing, wherein users 3 as potential purchasers 47 buy 48 the advertised goods and services.

FIG. 2 shows and explains the process of self promotion and marketing, wherein money traffic 49 goes from purchasers 47 to customers (advertisers) 1, thus completing the full technological cycle of spam.

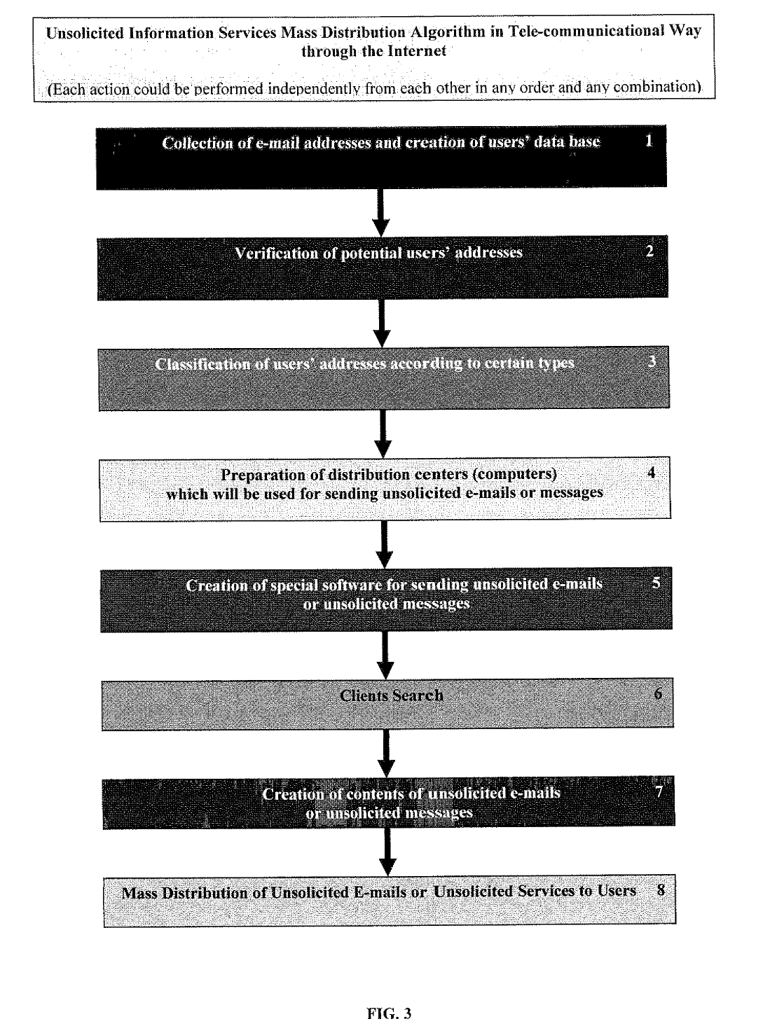

FIG. 3 shows and explains the algorithm of actions on organizing mass distribution of unsolicited information services in a tele-communicational way through the Internet, when every action can be fulfilled independently from each other.

FIG. 3 shows and explains the algorithm of actions on organizing mass distribution of unsolicited information services in a tele-communicational way through the Internet, wherein action 1 collection of e-mail addresses and creation of e-mail databases can be fulfilled by choosing names or popular words and phrases in dictionaries, as well as common combinations of words and numbers, for example, <<Gym@>>, <<spam@>>, <<dollar-27@>>.

FIG. 3 shows and explains the algorithm of actions on organizing mass distribution of unsolicited information services in a tele-communicational way through the Internet, wherein action 1 collection of e-mail addresses and creation of e-mail databases can be fulfilled by use of analogy method, for example, if there is an address Gym.User@gmail.com, then a search for Gym.User is initiated in different domains, such as yahoo.com, aol.com, hotmail.com.

FIG. 3 shows and explains the algorithm of actions on organizing mass distribution of unsolicited information services in a tele-communicational way through the Internet, wherein action 1 collection of e-mail addresses and creation of e-mail databases can be fulfilled by scanning all available sources of information, for example, web-sites, forums, chats, advertisement boards, Usenet, databases, to find combinations like <<word1@word2.word3.com>> or <<word1@word2. word3.info>> or <<word1@word2.word3.net>> and to create topical databases, for example, according to hobbies.

FIG. 3 shows and explains the algorithm of actions on organizing mass distribution of unsolicited information services in a tele-communicational way through the Internet, wherein action 1 collection of e-mail addresses and creation of e-mail databases can be fulfilled by buying databases of servers, providers, or buying users' personal data, for example, clients' address books, by using special computer software.

FIG. 3 shows and explains the algorithm of actions on organizing mass distribution of unsolicited information services in a tele-communicational way through the Internet, wherein action 2 is verification of potential users and their e-mail addresses, which is performed by use of trial distribution of unsolicited information services in the form of messages with random text and further analysis of responses from mail servers, which shows validity of every address from the list (whether the mail was received or not).

FIG. 3 shows and explains the algorithm of actions on organizing mass distribution of unsolicited information services in a tele-communicational way through the Internet, wherein action 2 is verification of potential users and their e-mail addresses, which is performed by placing a unique link to a picture on a www-server into the text of the message. When the letter is opened, the picture will automatically be visited, and the site owner will know that this e-mail address is valid.

FIG. 3 shows and explains the algorithm of actions on organizing mass distribution of unsolicited information services in a tele-communicational way through the Internet, wherein action 2 is verification of potential users and their e-mail addresses, which is performed by using a link “unsubscribe” in the message. For example, if a user follows this link, he/she does not get unsubscribed, but his/her address is marked as valid, and the user's activity is verified.

FIG. 3 shows and explains the algorithm of actions on organizing mass distribution of unsolicited information services in a tele-communicational way through the Internet, wherein action 3 is classification of e-mail addresses according to different types, i.e. regions, types of activity, hobbies, or lists of users' addresses from certain mail service, for example, Yandex, AOL, Hotmail, or certain service, for example, ebay, Paypal.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services, which can be performed by direct distribution from rented servers.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services, which can be performed by use of opened servers, for example, <<opened relays>> or <<opened proxy>>, which have been configured by the owners in such way that they can be used for distribution of unsolicited information services.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services, which can be performed by remote installation of special software on users' computers, which can provide remote access and administration of users' computers.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services from a lot of constantly renewed and replenished rented servers. And in this case mass distribution of unsolicited information services is performed only to those users whose mail servers do not use black-lists of IP addresses; special software is used for detecting and using opened servers, and this software scans all fields of address areas in the Internet with very high speed.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services from a lot of constantly renewed and replenished rented servers by remote installation of special software on users' computers, which can provide remote access and administration of users' computers.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services from a lot of constantly renewed and replenished rented servers; and installation of special software that can provide remote access and administration of users' computers is performed by including this software into unlicensed (pirate) software, or by modifying distributed software, or by including it into “key generators”.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services from a lot of constantly renewed and replenished rented servers; and installation of special software that can provide remote access and administration of users' computers is performed by distributing the software through file-exchange networks, for example, eDonkey, Kazaa, or through sites with <<warez>> as pirate copies of the software.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services from a lot of constantly renewed and replenished rented servers; and installation of special software that can provide remote access and administration of users' computers is performed by using weak spots in Internet browsers, for example, Microsoft Internet Explorer. For example, a number of versions of such programmes contain mistakes in the process of checking access rights, which allows placement of certain components on a web-site, which are automatically downloaded and installed on users' computers without users' awareness of that, and this allows remote administration and distribution of unsolicited information services from these computers.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services from a lot of constantly renewed and replenished rented servers; and installation of special software that can provide remote access and administration of users' computers is performed mainly through the sites that are often visited by users, for example, porno sites, and the distribution is performed following the scheme: mass remote access to sites working under MS ITS control is provided, and then web-pages on these sites are modified and special codes are activated, which results in putting viruses into users' computers.

FIG. 3 shows and explains the algorithm of actions on organizing mass distribution of unsolicited information services in a tele-communicational way through the Internet, wherein action 4 is preparation of computers that are “points of distribution” and are used for distribution of unsolicited information services from a lot of constantly renewed and replenished rented servers; and installation of special software that can provide remote access and administration of users' computers is performed by use of special software which is distributed through e-mail channels and uses weak spots in network services of Microsoft Windows; this software can look like ordinary Internet browsers which connect to web-sites in order to receive instructions for actions, for example, whether they should distribute unsolicited information services or make DoS attack. For example, such instructions may contain details of the time and “place” of the following instruction. Infected computers can also be rented. The requirement for “high sales” of the list brings to the ability of unsolicited special software to work in standard protocols, for example, HTTP or SOCKS proxy, with port numbers from a small list, which gives opportunity for their use by third parties.

FIG. 3 shows and explains the algorithm of actions on organizing mass distribution of unsolicited information services in a tele-communicational way through the Internet, wherein action 5 is design of software for distribution of unsolicited information services by quick distribution of large amounts of unsolicited information services, which is performed by a comparatively small number of programmes that are registered either as services available on subscription, or as programmes for sale.

FIG. 3 shows and explains the algorithm of actions on organizing mass distribution of unsolicited information services in a tele-communicational way through the Internet, wherein action 5 is design of software for distribution of unsolicited information services through quick distribution of a large number of unsolicited information services, which is performed by a programme that enables distribution of unsolicited information services through “opened services” (opened relays, proxy).

FIG. 3 shows and explains the algorithm of actions on organizing mass distribution of unsolicited information services in a tele-communicational way through the Internet, wherein action 5 is design of software for distribution of unsolicited information services through quick distribution of a large number of unsolicited information services, which is performed by a programme that enables distribution of unsolicited information services through infected users' computers.

FIG. 3 shows and explains the algorithm of actions on organizing mass distribution of unsolicited information services in a tele-communicational way through the Internet, wherein action 5 is design of software for distribution of unsolicited information services through quick distribution of a large number of unsolicited information services, which is performed by a programme that enables distribution of unsolicited information services by creating dynamic texts in messages or forging message titles.

FIG. 3 shows and explains the algorithm of actions on organizing mass distribution of unsolicited information services in a tele-communicational way through the Internet, wherein action 5 is design of software for distribution of unsolicited information services through quick distribution of a large number of unsolicited information services, which is performed by a programme that enables distribution of unsolicited information services, traces validity of e-mail address databases and status of messages to every single address, as well as forwarding messages through another “distribution point” in case if black-lists of IP addresses are used by recipients.

FIG. 3 shows and explains the algorithm of actions on organizing mass distribution of unsolicited information services in a tele-communicational way through the Internet, wherein action 6 is search for users by performing mass distribution of unsolicited information services, using different distribution software or using databases of e-mail addresses.

FIG. 3 shows and explains the algorithm of actions on organizing mass distribution of unsolicited information services in a tele-communicational way through the Internet, wherein action 7 is creation of text contents for unsolicited information services for certain specific distributions by use of simple distribution of the same or almost the same unsolicited information services, or individual unsolicited information services which contents differs from each other.

FIG. 3 shows and explains the algorithm of actions on organizing mass distribution of unsolicited information services in a tele-communicational way through the Internet, wherein action 7 is creation of text contents for unsolicited information services for certain specific distributions by use of random text, “noise” or hidden text, for example, random choice or words or an abstract from a classical text can be placed in the beginning or in the end of a message, or “hidden” text can be placed in a HTML message, for example, tiny text or text with the font color being the same as the background color.

FIG. 3 shows and explains the algorithm of actions on organizing mass distribution of unsolicited information services in a tele-communicational way through the Internet, wherein action 7 is creation of text contents for unsolicited information services for certain specific distributions by use of graphic messages, for example, an advertisement is distributed to users in the form of a graphic file, or by use of changeable graphic messages, or placing “noises” into graphic messages.

FIG. 3 shows and explains the algorithm of actions on organizing mass distribution of unsolicited information services in a tele-communicational way through the Internet, wherein action 7 is creation of text contents for unsolicited information services for certain specific distributions by use of changing wordings in texts, for example, when the same message is composed in a number of versions of the same text, and every message looks like an ordinary coherent text.

FIG. 3 shows and explains the algorithm of actions on organizing mass distribution of unsolicited information services in a tele-communicational way through the Internet, wherein action 7 is creation of text contents for unsolicited information services for certain specific distributions, which are supported by special distribution software.

FIG. 3 shows and explains the algorithm of actions on organizing mass distribution of unsolicited information services in a tele-communicational way through the Internet, wherein action 8 is the process of mass distribution of unsolicited information services itself.

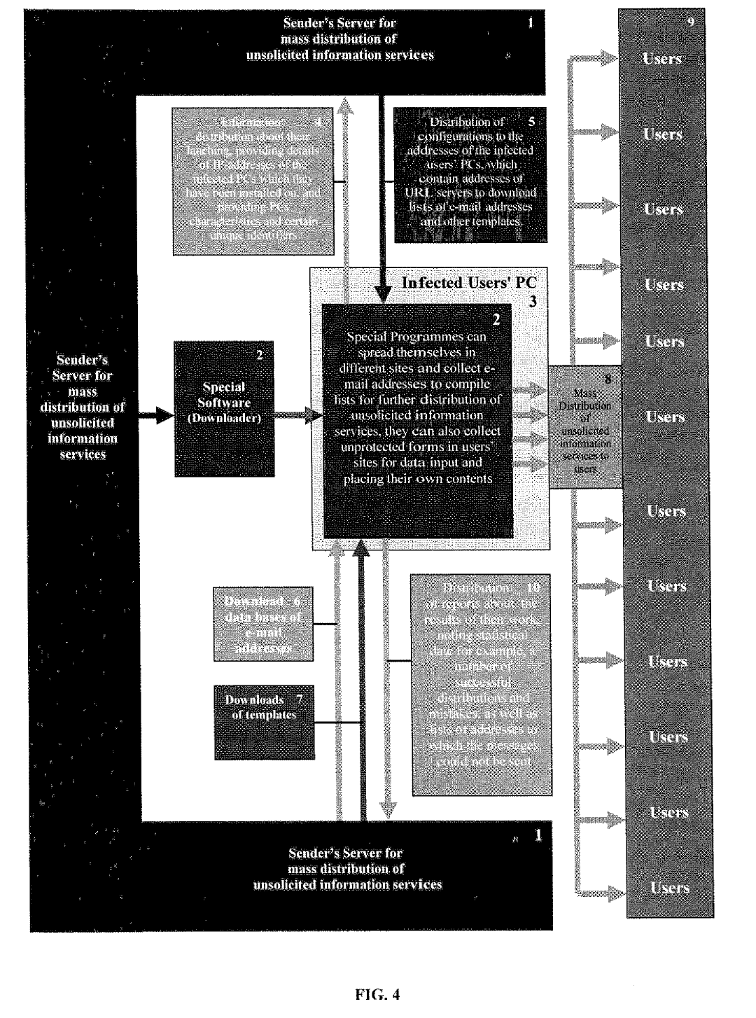

FIG. 4 shows and explains the process of mass distribution of unsolicited information services, performed in a tele-communicational way through the Internet by use of special software, such as Downloader, which provides remote access and administration of users' computers.

FIG. 4 shows and explains the process of mass distribution of unsolicited information services, performed in a tele-communicational way through the Internet, when special programmes 2, such as Downloader, are installed remotely from sender's server 1 onto users' computers 3, and such special programmes 2 can spread themselves in different sites and collect e-mail addresses to compile lists for further distribution of unsolicited information services, they can also collect unprotected forms in users' sites for data input and placing their own contents. Special programmes 2, after having been installed on users' computers 3, connect to their senders' servers 1 and send information 4 about their launching, providing details of IP addresses of the infected computers which they have been installed on, and providing computer characteristics and certain unique identifiers. In a response, servers 1 send configurations 5 to the addresses of the infected users' computers 3′ which contain addresses of URL servers to download lists of e-mail addresses and other templates. Then special programmes 2 download databases of e-mail addresses 6 and templates 7 and perform mass distribution 8 of unsolicited e-mails or unsolicited messages to users 9, and at the same time they modify texts, supplement texts with pictures, or transform texts into graphic images according to set algorithms and templates. Then, after the mass distribution of a certain portion of unsolicited e-mails or unsolicited messages have been completed, special programmes 2 send to their senders' servers 1 a report 10 about the results of their work, noting statistical data, for example, a number of successful distributions and mistakes, as well as lists of addresses to which the messages could not be sent.

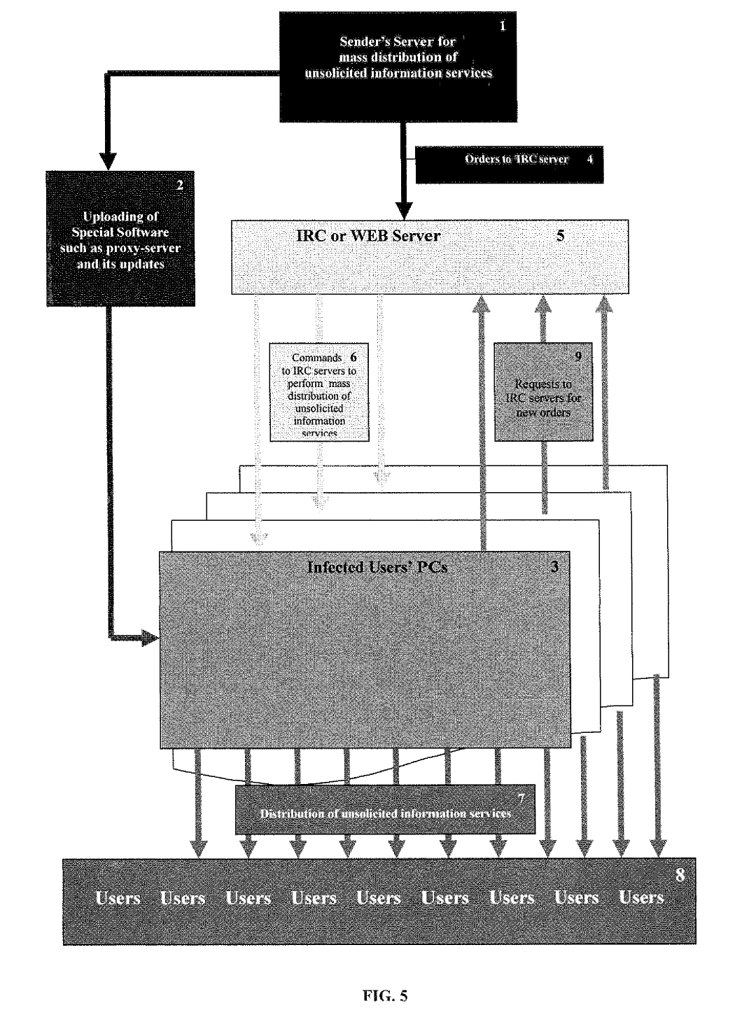

FIG. 5 shows and explains the process of mass distribution of unsolicited information services, performed in a tele-communicational way through the Internet, when special programmes 2, such as proxy-server and its updates, are installed remotely from sender's server 1 onto users' computers 3. Then server 1 gives orders 4 to IRC servers 5 to perform mass distribution of unsolicited information services. Then IRC server 5 retranslates orders 6 to all infected users' computers 3 for mass distribution 7 of unsolicited e-mails or unsolicited messages to users 8. After a certain portion of distributions have been completed, special programmes 2 send requests to IRC servers 5 for new orders 9.

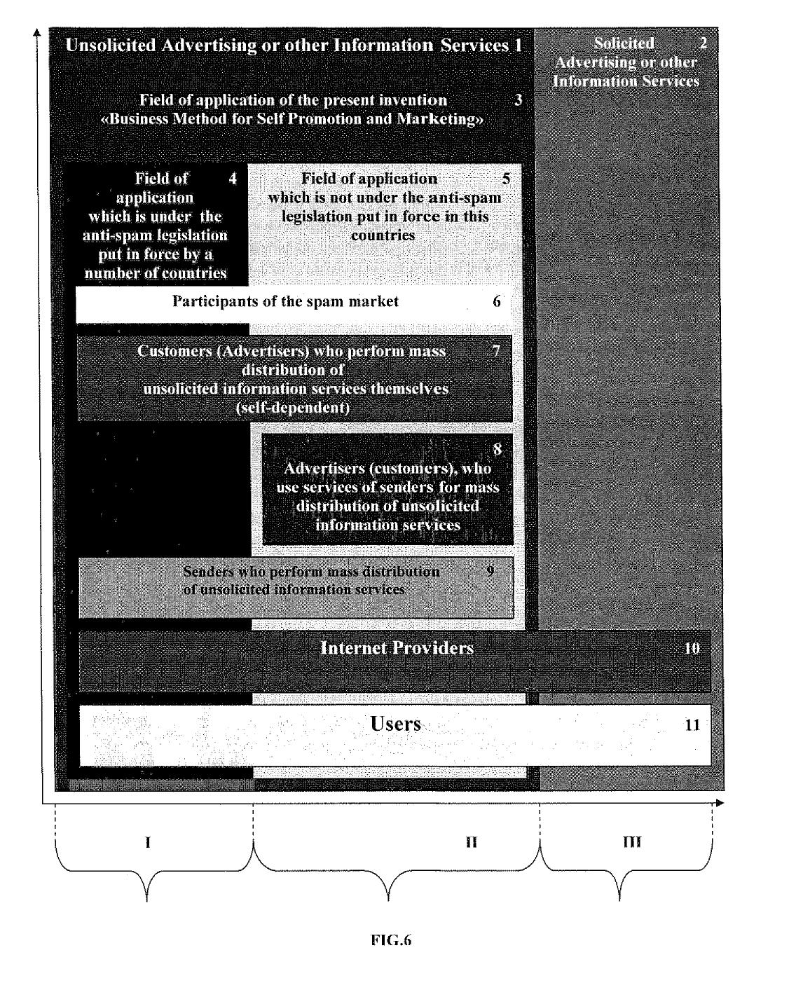

FIG. 6 shows the diagram explaining the field of application for the present invention. The diagram is divided into two fields, i.e.: Field 1 of unsolicited advertising or other unsolicited information services and field 2 of solicited advertising or other solicited information services. Field 1 of unsolicited advertising or other unsolicited information services is the field of application of the present invention 3. In its turn, the field of application of the present invention 3 is divided into the field 4, which is under the anti-spam legislation put in force by a number of countries, and the field 5, which is not under the anti-spam legislation put in force in these countries. The diagram shows that all participants of the spam market 6 have different fields of activity and different responsibility for breaking the anti-spam legislation in different countries. Advertisers (customers) 7, who perform mass distribution of unsolicited information services themselves (self-dependent), have activities in both field 4 and field 5. Thus, advertisers (customers) 7 break the anti-spam legislation which is put in force in different countries (field 4), as well as violate the patent rights of the present invention (fields 4 and 5). Advertisers (customers) 8, who use services of senders 9 for mass distribution of unsolicited information services, have activities in field 5 and do not break the anti-spam legislation which is put in force in different countries, but they do violate the patent rights of the present invention (field 5). Senders 9, who perform mass distribution of unsolicited information services, have activities in both field 4 and field 5. Thus, senders 9 break the anti-spam legislation which is put in force in different countries (field 4), as well as violate the patent rights of the present invention (field 5). Internet providers 10, who also perform mass distribution of unsolicited information services, have activities in both field 4 and field 5, and field 2 as well. Thus, providers 10 break the anti-spam legislation which is put in force in different countries (field 4), as well as violate the patent rights of the present invention (field 5). Users 11 neither break the anti-spam legislation, nor violate the patent rights, they are the only victims out of all participants of the spam market.

### CONCLUSION

The diagram on FIG. 6 shows that the main infringers of anti-spam laws are either customers (advertisers) 7 who distribute unsolicited information services themselves, or senders 9 of unsolicited information services. The task of determining who senders are is quite hard, and it is practically impossible to influence on senders due to the absence of corresponding legislation.

Customers (advertisers), on the contrary, are known, but it is useless to make complaints about them, as far as they do not distribute anything themselves, and it is impossible to prove that they are the customers (advertisers) of mass distribution of unsolicited information services.

Thus, it is very difficult to protect users 11 from reading undesirable messages by use of traditional technical (different anti-spam filters) and legal measures, and it practically impossible to protect users 11 from receiving unsolicited information services on a technical or legal level, as far as spam brakes filters anyway in major cases.

The most effective way of protecting users from mass distribution of unsolicited information services is the present invention which allows use of legal means against all customers (advertisers) and senders of spam who infringe the author's right of the present invention.

What is claimed is:

1. A business method for self promotion and marketing is performed through mass influence on users by means of tangible or intangible unsolicited information services or other unsolicited person's or legal entity's attributes of personal, pseudo-personal or impersonal character or by means of their mass distribution to users through the use of visual, sound, communicational, tele-communicational and others ways of distribution from hidden or real addresses and under real or false names of senders, using radio, television, telephone, mail, signs, posters, monitors, the Internet, and other tangible or intangible unsolicited information services or other unsolicited person's or legal entity's attributes, that cause increase of mail, telephone, e-mail and other traffic and result in increase of demand for products and services, which encourages users to buy these products and services or other person's or legal entity's attributes.

2. The method of claim 1, wherein customers, senders and users of unsolicited information services are persons or legal entities, which can live in the same country or in different countries, and, moreover, customers and senders can be the same persons or legal entities, and distribution of unsolicited information services can be performed from hidden, anonymous or real addresses of senders with the use of real or false names of senders, or it can be done from senders' addresses that use pseudonyms to real users' addresses, or to users' addresses that use anonymous pseudonyms.

3. The method of claim 1, wherein unsolicited information services comprise tangible or intangible information services or other tangible or intangible unsolicited person's or legal entity's attributes of advertising, commercial, non-commercial, impersonal, pseudo-personal or personal character, for example, unsolicited mail in the form of letters, postcards, musical cards, newspapers, magazines, commercials, brochures, flyers; unsolicited radio or television commercials, advertisements, announcements, video clips; unsolicited telephone calls and messages; unsolicited e-mail correspondence and other Internet messages; unsolicited visual information services placed on posters, stands, boards, screens, monitors and other means of visual unsolicited information services.

4. The method of claim 1, wherein influence on users is performed through mass or individual and partial, constant or periodic, repeated or single, manual or automatic distribution of unsolicited information services or other person's or legal entity's attributes.

5. The method of claim 1, wherein visual or sound influence of unsolicited information services on users is performed in a communicational, tele-communicational way or by post using radio, television, Internet, cable or mobile telephone connection, fax, IP telephony or other tangible or intangible means of unsolicited information services distribution, which increase mail, telephone, tele-communicational and other traffic and result in increase of demand for goods, services or other person's or legal entity's attributes.

6. The method of claim 1, wherein visual or sound influence of unsolicited information services on users is performed by means of unsolicited correspondence distribution, for example, in the form of letters, postcards, musical cards, newspapers, magazines, commercials, brochures, flyers, or other tangible means of unsolicited information services distribution, which increase mail traffic and result in increase of demand for goods and services.

7. The method of claim 1, wherein visual or sound influence of unsolicited information services on users is performed by communicational way using verbal or gestural means, for example, orally or in the written form with the help of music, songs, gestures, pantomime, mimicry and other inductive means that increase human traffic and result in increase of demand for goods and services.

8. The method of claim 1, wherein visual or sound influence of unsolicited information services on users is performed in a tele-communicational way by means of fixed stands, posters, screens, monitors and other visual or sound fixed and portable means of unsolicited information services, placed inside or outside, on vehicles, in squares, and in other public places, that increase human traffic and result in increase of demand for goods and services.

9. The method of claim 1, wherein sound influence of unsolicited information services on users is performed by use of radio and other inductive sound means of unsolicited information services that increase human traffic and result in increase of demand for goods and services.

10. The method of claim 1, wherein visual or sound influence of unsolicited information services on users is performed by use of television and other visual, sound, tele-communicational inductive means of unsolicited information services that increase human traffic and result in increase of demand for goods and services.

11. The method of claim 1, wherein visual or sound influence of unsolicited information services on users is performed by use of cable or mobile telephone and fax connection, for example, by making unsolicited calls or sending unsolicited messages manually or by using a remote administration of SMS-gates operators of mobile connection through the Internet, or sending unsolicited messages from operators that promote their services or other tele-communicational means of inductive information services that increase telephone and other tele-communicational traffic and result in increase of demand for goods and services.

12. The method of claim 11, wherein distribution of unsolicited information services to users is performed in a visual, sound and tele-communicational way by use of mobile telephone Bluetooth technology, for example, by launching special programmes on computers which are equipped with special devices and antennas for detecting mobile telephone numbers belonging to certain mobile operator and making them do optional unsolicited calls or unsolicited messages to optional telephone numbers of users.

13. The method of claim 11, wherein distribution of unsolicited information services to users is performed in a visual, sound and tele-communicational way by use of mobile telephone Bluetooth technology, for example, by launching special software detecting unprotected mobile telephone numbers and copying all data from address books, calendars, pictures and other information stored on the phones, and then sending optional unsolicited messages or calls from these telephone numbers to optional telephone numbers of users.

14. The method of claim 1, wherein distribution of unsolicited e-mails, messages or other information services to users is performed in a visual, sound and tele-communicational way by use of the Internet for sending unsolicited e-mails or unsolicited messages, for example, through mobile instant messaging (MIM) service, MMS service, MSN service or by using other inductive internet based technologies that increase Internet traffic and result in increase of demand for goods and services.

15. The method of claim 14, wherein distribution of unsolicited e-mails, messages or other information services to users is performed in a visual, sound and tele-communicational way through the Internet by use of special software which enables remote access, control and administration of users' resources, collection of users' e-mail addresses and distribution of unsolicited e-mails or unsolicited messages to these addresses.

16. The method of claim 14, wherein distribution of unsolicited e-mails, messages or other information services to users is performed through the Internet by using the following algorithm: collection of e-mail addresses and creation of users' database; verification of users' addresses; classification of users' addresses according to certain types; preparation of distribution centers (computers) which will be used for sending unsolicited e-mails or messages; development of special software for sending unsolicited e-mails or messages; clients search; creation of contents of unsolicited e-mails or messages for certain distributions; distribution of unsolicited e-mails or messages.

17. The method of claim 14, wherein distribution of unsolicited e-mails, messages or other information services to users is performed through the Internet on an individual basis in the form of personalized unsolicited e-mails or messages that contain differences in the text.

18. The method of claim 14, wherein distribution of unsolicited e-mails, messages or other information services to users is performed through the Internet by use of mail servers (open relays), which enable sending of optional unsolicited e-mails or unsolicited messages to optional users on optional addresses.

19. The method of claim 14, wherein distribution of unsolicited e-mails, messages or other information services to users is performed through the Internet from modem pools by using mail servers of providers that receive mail from their users and then send it to other users, or by using dial-up connections and numerous dynamic IP-addresses which are changed when each connection is performed and thus enable to send unsolicited e-mails or unsolicited messages from these dynamic IP-addresses, or by changing routes for distribution of unsolicited e-mails or unsolicited messages between users.

20. The method of claim 14, wherein distribution of unsolicited e-mails, messages or other information services to users is performed through the Internet from personal computers which are remotely equipped with unsolicited special software which enables distribution within the computer network and allows senders of unsolicited e-mails or unsolicited messages to remotely access, control and administrate users' computer and traffic resources without their awareness and control.

21. In the present invention, distribution of punsolicited e-mails, messages or other information services to users is performed through the Internet by use of special software for example, Firefox, Internet Explorer or other web-browsers, which provide remote access, control and administration of network's printers, with the opportunity for printers to perform unsolicited actions, for example, starting printing of unsolicited advertisements (cross-site printing), sending of unsolicited faxes, formatting hard disc, uploading of special software.

22. The method of claim 14, wherein distribution of unsolicited e-mails, messages or other information services to users is performed through the Internet by use of different protocols for distribution of unsolicited e-mails or unsolicited messages to users.

23. The method of claim 14, wherein distribution of unsolicited e-mails, messages or other information services to users is performed through the Internet by use of random choice of data or any e-mails' or messages' parameters that contain random text, invisible text or “noise”.

24. The method of claim 14, wherein distribution of unsolicited e-mails, messages or other information services to users is performed through the Internet by use of graphic files, for example, files containing 3D (3 dimension) graphic images with colored dots or lines distorting text or containing text written using different types and prints and thus creating a 3D (3 dimension) image.

25. The method of claim 14, wherein distribution of unsolicited e-mails, messages or other information services to users is performed through the Internet by use of files with animation consisting of several slides, one of which contains the main message and is shown for a longer time than the other slides that contain background information or other picture elements that do not have significant meaning, as well as files with animated graphics, for example, GIF animation.

26. The method of claim 14, wherein distribution of unsolicited e-mails, messages or other information services to users is performed through the Internet by use of 3D (3 dimension) graphic images with text which are unique for every user, for example, uniquely generated images that are part of unsolicited e-mails or messages sent in PDF and FDF formats for Adobe Acrobat.

27. The method of claim 14, wherein distribution of unsolicited e-mails, messages or other information services to users is performed through the Internet by use of simple text messages with the same contents or paraphrased text messages when the same information is conveyed through a number of different variants of the same text.

28. The method of claim 14, wherein distribution of unsolicited e-mails, messages or other information services to users is performed through the Internet by use of special scripts that compare users' IP-addresses with the database of search robots and do the query variables analysis, which shows to the search robot an optimized version of the site contents and provides the user with a usual layout of the site which is different from the one shown to the robot.

29. The method of claim 14, wherein distribution of unsolicited e-mails, messages or other information services to users is performed through the Internet from unlimited number of sites or e-mail addresses by generating unlimited number of new domain names or e-mail addresses, when changing any letter or number, except for the first and the last ones, in any word of the text with either <<hyphen>>, <<dot>>, or <<@>.

30. The method of claim 14, wherein distribution of unsolicited e-mails, messages or other information services to users is performed through the Internet by adding extra spaces in users' addresses and/or changing symbol “@” to “at”, and/or dot to “dot”.

31. The method of claim 14, wherein distribution of unsolicited c-mails, messages or other information services to users is performed through the Internet by mixing letters from different languages in users' addresses.

32. The method of claim 14, wherein distribution of unsolicited e-mails, messages or other information services to users is performed through the Internet from a number of hidden, obtained or rented addresses or real senders' addresses under real or false names in different languages with different speed, interval, frequency and size of distribution.

33. The method of claim 14, wherein distributed unsolicited e-mails, messages or other information services contain formal characteristics of distribution, which can be used by users or providers to distinguish topics of unsolicited e-mails or unsolicited messages.

34. The method of claim 14, wherein distributed unsolicited e-mails, messages or other information services do not have certain contents and are vague, unclear and contradictory, and do not provide proof of their authenticity in the following distribution of unsolicited e-mails or unsolicited messages which explain the context of the previous e-mails or other messages.

35. The method of claim 14, wherein distribution of unsolicited e-mails, messages or other information services to users is performed through the Internet by creating memory for every unsolicited e-mail or message which has been sent, for example, by using cryptographic electronic “stamp” or “stamp of approval”.

36. The method of claim 14, wherein distribution of unsolicited e-mails, messages or other information services to users is performed through the Internet by use of special software from a number of IP addresses to a certain chosen IP address, which increases network traffic to the level when other users' access to this chosen IP address gets partially or fully blocked.

37. The method of claim 14, wherein distribution of unsolicited e-mails, messages or other information services to users is performed through the Internet by creating web-sites that contain popular phrases or word combinations, as well as key words which are often repeated in search queries or contain invisible text or tiny text or by redirecting users to other sites.

38. The method of claim 14, wherein distribution of unsolicited e-mails, messages or other information services to users is performed through the Internet by creating and distributing in search index an unlimited number of special doorway pages which are set to certain search criteria and ensure increase of the page rank of the main web-site due to link popularity, that redirects all queries to a certain web-site, as well as by further registration of these pages and links from them to the main web-site in a huge number of topical catalogues, by exchanging or acquiring links, including getting links from visitors' pages, forums, wiki, or by creating and using automatically generated blogs or splogs.

39. The method of claim 14, wherein distribution of unsolicited e-mails, messages or other information services to users is performed through the Internet by mutual exchange of data, during which the traffic of search engines goes one way, and the contents of unsolicited e-mails or messages goes the opposite way. The content is supported by certain infrastructure which includes the following: operators that provide access to site contents and thus make it available for further use; operators that provide gathering of information in mass volumes; redirection of domains system that provides redirection to doorway-pages.

40. The method of claim 14, wherein distribution of unsolicited e-mails, messages or other information services to users is performed through the Internet, unsolicited e-mails or messages have inductive character which influences on securities price, for example, certain stock price which are used at the off-exchange market in the Internet trade systems and which encourage users to buy securities from senders or third parties for a bigger price and sell them for a lower price.

41. The method of claim 14, wherein distribution of unsolicited e-mails, messages or other information services to users is performed through the Internet using the following algorithm of activities: senders do mass and multiple distribution of different unsolicited e-mails or messages to users, which brings to increase of network traffic and partial or full blocking of access to users' servers; senders do further mass and multiple distribution of unsolicited e-mails or messages to users, which contain offers to stop this mass distribution for a certain price and give payment details; after payments from certain users are received to the mentioned accounts, the senders stop mass distribution to the users' addresses either temporarily, partially or fully.

42. The method of claim 14, wherein distribution of unsolicited e-mails, messages or other information services to users is performed through the Internet by use of special software which creates potentially feasible e-mail addresses and sends unsolicited e-mails or messages to these addresses. Then all queries done to non-existing addresses are excluded, and the addresses that have not been excluded are considered to be existing, they are included in the database and then used for further mass distribution which brings to increase of network traffic and partial or full blocking of access to users' servers.

43. The method of claim 14, wherein distribution of unsolicited e-mails, messages or other information services to users is performed through the Internet by senders from real addresses and under real names till the moment when they receive a note saying that users do not wish to receive these messages, which allows users to unsubscribe from receiving messages from certain departments or services.

44. The method of claim 14, wherein distribution of unsolicited e-mails, messages or other information services to users is performed through the Internet under the names of newly established organizations, for example, companies that are established on a daily basis.

45. The method of claim 14, wherein distribution of unsolicited e-mails, messages or other information services to users is performed through the Internet from an anonymous address, for example, anonymous@everywhere.com or anonymous@nowhere.com that allows users to filter distribution according to certain criteria and put it in special folders.

46. The method of claim 14, wherein distribution of unsolicited e-mails, messages or other information services to users is performed through the Internet by use of systems with substitution of synonymous meanings, IP addresses virtualization or substitution of synthetic data in the service fields of mail servers.

47. The method of claim 14, wherein distribution of unsolicited e-mails, messages or other information services to users is performed through the Internet by use of special software which allows using an infected user's computer in such a way, that all distribution of unsolicited e-mails or messages goes through the mail server of the provider to which the infected computer is connected, and the infected computer itself does not send anything at all to new potential users.

48. The method of claim 14, wherein distribution of unsolicited e-mails, messages or other information services to users is performed through the Internet by remote launching of special software on users' computers, which allows remote control and administration of the computers using applications of Microsoft Excel and Power Point, for example Office 97, Office XP, that have special function of checking which, each time when a document is opened, gives warning to the user to disable automatic use of macros; and such remote launching of special software is performed right after a document is opened using one of these applications.

49. The method of claim 14, wherein distribution of unsolicited e-mails, messages or other information services to users is performed through the Internet by installing special universal utilities on users' computers, which creates special self-multiplying software that provides remote access and administration of users' computers and turns them into proxy-servers for distribution of unsolicited e-mails or messages.

50. The method of claim 14, wherein distribution of unsolicited e-mails or unsolicited messages to users is performed through the Internet by creation of special assigned advertising channel, and special marking can be placed in headlines of distributed unsolicited e-mails or unsolicited messages, for example, <<Advertisement>>, and special alias is created on a mail server, for example, advertisement@smtp.server.com, which has an official e-mail address on the server and an official general folder, for example. <<Advertisement>>, which is used by the sender for performing distribution of unsolicited e-mails or unsolicited messages.
